(19) United States
(12) Patent Application Publication
(10) Pub. No.: US 2006/0090020 A1
(43) Pub. Date: Apr. 27, 2006

(54) Connector for satellite radio-computer interface

(75) Inventors: Elliott D. Frutkin, Gaithersburg, MD (US); Harry J. Schechter, Washington, DC (US); G. Scott MacLean, Bolton (CA)

Correspondence Address: WATTS, HOFFMANN CO., L.P.A.;Ste. 1750, 1100 Superior Ave., Cleveland, OH, 44114, US

(73) Assignee: Time Trax Technologies Corporation

(21) Appl. No.: 10/961,854

(22) Filed: Oct. 8, 2004

(51) Int. Cl. G06F 13/38

(52) U.S. Cl. 710/62

(57) ABSTRACT

Circuitry and method including communications capability for converting from one format signal to a second format signal. An input connector couples an RS-232 input to a conversion circuit provided from a source of RS-232 audio signals. An output connector coupled to the conversion circuit provides audio signals that have been reformatted to Universal Serial Bus format signals. The preferred use is for use with a satellite radio receiver for coupling radio signals from the receiver to a computer having a USB port.

### FIELD OF THE INVENTION

The present invention concerns an interface for providing radio signals to a computer for storage and replay at a later time.

### BACKGROUND ART

There are currently at least two providers of subscription satellite radio services. These providers lease a car-mounted radio receiver that decodes radio signals and provides an analog output signal to a car mounted amplifier and speakers. The motorist having such a receiver can tune to a large and growing number of different satellite radio stations. These receivers decode digital signals that are currently broadcast from transmitters carried by orbiting satellites to a wide broadcast area.

One existing receiver receives its operating power from the car battery by means of a male plug that mates with a female connector on the receiver. Additionally, the existing receiver has a serial communications capability for communicating song titles and time of play information for the motorist on a dash mounted control that includes a visual display and also includes actuators for selecting different radio stations on an available list of such stations. Two way serial communications between the receiver and the control allow the motorist to issue commands to change the station for example, and also allow play duration and song titles to be presented on the control's visual display.

The serial communications supported by an existing receiver supports serial data transmission in so-called RS-232 format. Details of the mechanical, electrical and functional specifications for this protocol are available in the text entitled “Computer Networks” by Andrew Tannenbaum, Prentice Hall, 1989. The RS-232 protocol supports two way (duplex) communications with a handshake agreement based on a sequence of transmissions. Once the source and recipient agree on the originator of large blocks of data, this data can be sent from the source to the recipient at a steady stream at a rate depending on the hardware that implements the interface. In the present instance, the source is either the receiver which sends data concerning the song being played or the control for setting the radio station of the receiver.

One goal of the present invention is to provide an interface whereby the RS-232 signal provided by the existing receiver is transmitted to a computer rather than a display on a car dashboard.

### SUMMARY OF THE INVENTION

One embodiment includes a first connector for coupling an input signal from a receiver, such as a satellite radio receiver, to an electronics module. The input signal can be either a RS-232 format signal or Universal Serial Bus format signal. A second connector coupled to said electronics module provides an output signal to a computer. The output signal can be either a RS-232 format signal or Universal Serial Bus format signal. A power supply that provides power to the electronics module and additionally the electronics module includes a voltage regulator for providing power to the receiver through the first connector.

Another embodiment of the invention is an assembly that includes a power supply for providing a direct current signal for powering circuit components that include a communications circuit. The communications circuit includes a communications capability for transmitting serial data from a receiver to a computer. The assembly also includes a first connector for coupling an input to the communications circuit from the receiver and a second connector coupled to the communications circuit for providing signals to an interface of said computer.

Another exemplary embodiment has an assembly that powers the receiver with a regulated direct current signal and also includes a conversion circuit for converting information content transmitted to the receiver from a first format to a second format. An input connector couples the conversion circuit to a source of signals of the first format. An output connector coupled to the conversion circuit provides signals of the second format signal to an output.

In this exemplary embodiment, the first format signals are communications signals formatted in RS-232 format and the second format are communications signals formatted in a Universal Serial Bus (USB) format. This provides music listeners information regarding song title, song type, and song duration to help in storing the music on a computer medium. The conversion to USB facilitates use by those users having computers (generally newer computers) that are not equipped with a standard RS-232 serial connector.

Regardless of what serial transfer protocol is used, software on the computer manages the storing and organization of the music that is received from the receiver. This software also maintains the two-way communications between the computer and the receiver for display of information and setting of the radio station that is received.

These and other objects advantages and features of the invention will be better understood when reviewed in conjunction with the accompanying drawings.

### BRIEF DESCRIPTION OF THE DRAWINGS

FIG. 1 is a perspective view of an assembly that includes two connectors and a module which contains electronics for converting from one format signal to a second format signal;

FIGS. 2A, 2B and 2C are detailed schematics of circuitry for practicing the invention;

FIGS. 3A and 3B are perspective views of an alternate housing for the components of the FIG. 1 assembly; and

FIG. 4 is a schematic depiction of a computer and receiver coupled to the system using the alternate housing construction.

### EXEMPLARY EMBODIMENT FOR PRACTICING THE INVENTION

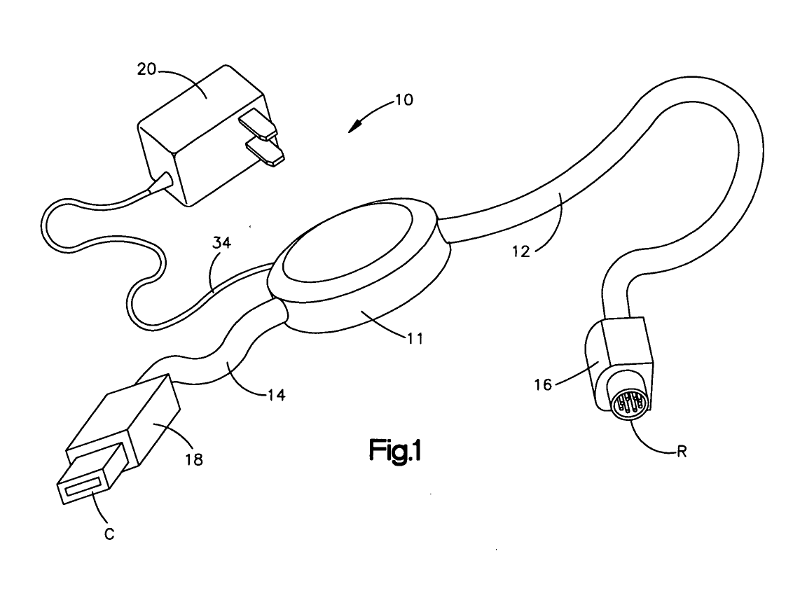

FIG. 1 depicts an assembly 10 that interposed between a radio receiver R and a serial interface such as a USB port of a computer C. The assembly transmits serial communications signals from the receiver R to the computer C. In one exemplary embodiment the assembly converts a first format serial signal to a second format serial signal that is coupled to the computer C. In this exemplary embodiment the assembly 10 also powers the radio receiver R.

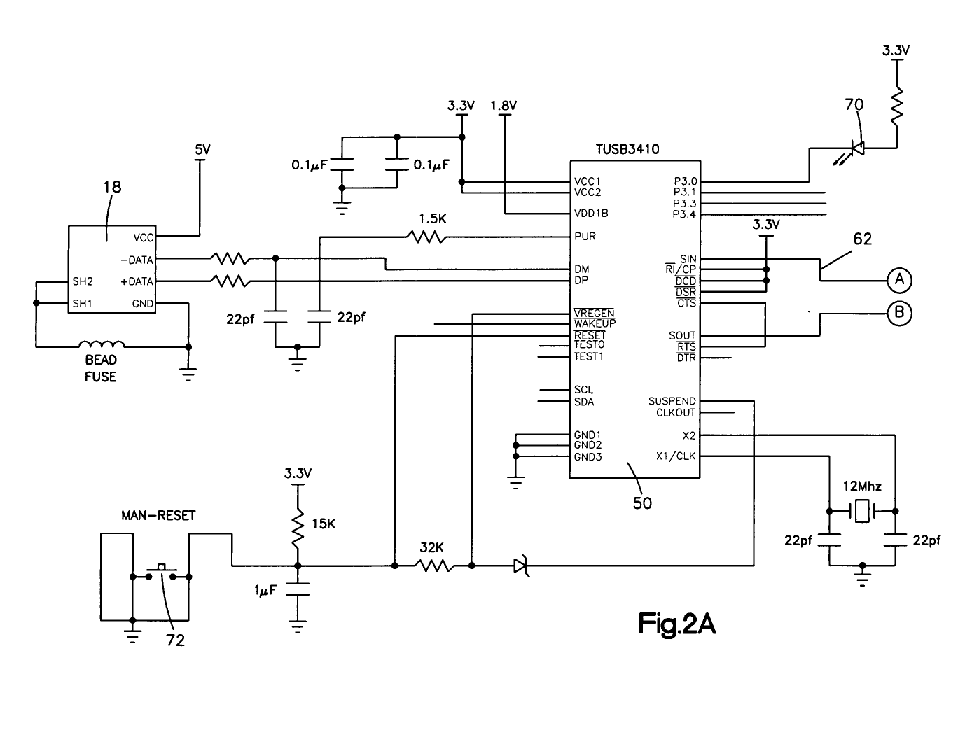

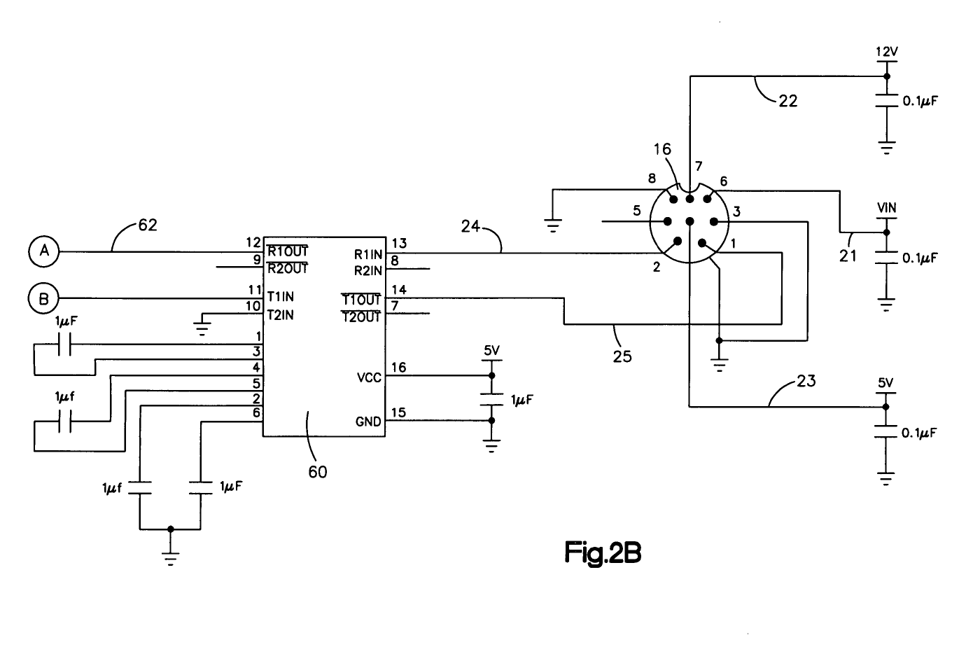

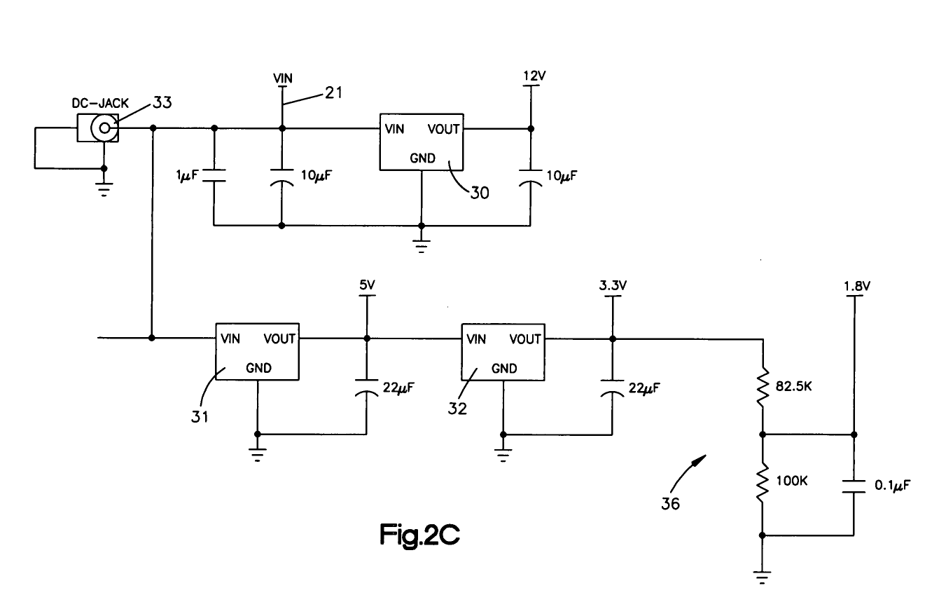

As noted, an existing, prior art satellite radio receiver R receives satellite radio signals and includes an analog output coupled by a cable 13 (FIG. 4) between the receiver R and the computer C which transmits audio input to the headphones input (not shown) of the computer C. FIG. 1 includes an electronics module 11 coupled by conductor carrying cables 12, 14 to two connectors 16, 18. A first connector 16 is preferably an eight pin mini-din connector that mates with an existing radio receiver unit R. The configuration of the eight pins of this connector is depicted in FIG. 2C. In addition to the ground connection, the pins of the receiver's mini-din female pins receives an unregulated signal of 12 volts DC at an input 21, a regulated power signal of 12 volts at an input 22, and a regulated enable signal of five volts at an input 23. The receiver R communicates information concerning listening content by outgoing RS-232 signals at an output 24. The receiver R responds to incoming RS-232 signals regarding listener choice of station at an output 25.

A power supply 20 (FIG. 1) having a standard transformer and rectifier creates an 12 volt DC output that is coupled by a cord 34 to the module 11 for powering circuit components contained within the module 11 as well as the receiver R. The module supports three voltage regulators 30, 31, 32 (FIG. 2C) that are coupled to the direct current signal at the input 21 (typically 12 volts DC) from the power supply 20. The module includes a standard DC input jack 33 for coupling an output from the power supply to these voltage regulators. The regulator 30 provides regulated 12 volt output and the regulator 31 provides the enable voltage signal of 5 volts DC that is coupled to the receiver R. The third voltage regulator 32 supplies power of 3.3 volts DC to other circuit components contained in the module 11. A voltage divider 36 provides a stepped down voltage of 1.8 volts.

The module 11 also includes a circuit 50 (FIG. 2A) for receiving RS-232 format signals from the receiver R and converting those signals to USB format signals. The exemplary system includes a model TUSB3410 USB to Serial port controller 50 commercially available from Texas Instruments. A Data Manual dated November 2003 published by Texas Instruments Incorporated describes the operation and functioning of this circuit and is incorporated herein by reference. The controller 50 contains necessary logic to communicate with the computer using the computer's USB bus. It contains a microcontroller unit and RAM and ROM for configuring the USB port of the computer when power is applied by the power supply 20.

The input connector 16 couples its RS-232 input 24 through a low level RS-232 handshake circuit 60 which co-ordinates RS-232 serial data transmission with a similar low level handshake circuit in the receiver R. The handshake circuit is a MAX 232 integrated circuit from Dallas Semiconductor. The circuit serves to pass the RS-232 signals from the receiver R to the controller in a controlled manner without overflow of data. To implement this function the circuit 60 changes signal levels from the receiver R to the circuit 50 as well as converting the signal levels of the signals sent by the circuit 50 to the receiver. One commercially available receiver R is made available to customers by XM Satellite Radio of Washington, DC.

An output 62 from the circuit 60 is coupled to the controller 50 which converts the RS-232 formatted signals from the circuit 60 into signals satisfying the USB format. A summary of the USB format is available from the web site www.usb.org. The USB controller is a slave device to the computer C. It responds to control transaction requests from the computer such as requests for data from the receiver R. The controller sends and receives data to/from the computer C using a standard USB data format. Generally, the difference between a logic state of “1” and logic state of “0” for signals at the USB port is discerned by the computer based on the voltage difference between two Data inputs to the connector 18. The circuit 50 generates standard USB signals from the incoming RS-232 signals and transmits information containing song title, type and duration to the computer C.

Other signals originate at the computer C. One example of such a signal is generated by software on the computer to cause the receiver to change to a different radio station. These signals are transmitted by the computer through an appropriate USB connector to the circuit 50 which converts the USB formatted signals to RS-232 signals. The circuit 50 then transmits the commands to the T1ᵢₙ input of the circuit 60. This circuit 60 then negotiates a transfer to the receiver R of the command along the conductor 25 that is connected to the connector 16 which mates with a female connector of the receiver R. The communications protocol implemented by the software running on the computer C implements full duplex communications. The software executing on the computer C categorizes and stores the song (or other audio) in a manner controlled by the listener. The USB connector 18 conforms to the USB 2.0 standard and is well documented in the literature.

The circuit of FIGS. 2A, 2B and 2C includes debugging circuit components to facilitate modification of the default software that is included with the controller 50. To facilitate debugging the circuitry includes a light emitting diode 70 and a manual reset switch 72. When the controller is sending or receiving data a signal at an output 74 connected to the diode 70 causes the diode to conduct and thereby emit light.

In summary, the module 11 supplies power to the receiver R in the form of a regulated twelve volt DC signal and first enables RS-232 data transmission and then converts the received data from that format into a USB formatted signal for coupling to the computer C. Software executing on the computer C coordinates the analog audio output from the receiver with the song data transmitted by the module 11 to the computer. One suitable source of software for this function is the assignee of the present invention, Time Trax Technologies, Inc., having a place of business at 12154 Darnestown Road, Suite 440, North Potomac, Md., 20878. This software organizes, filters, and stores the audio content from the receiver R.

### Alternate Embodiment

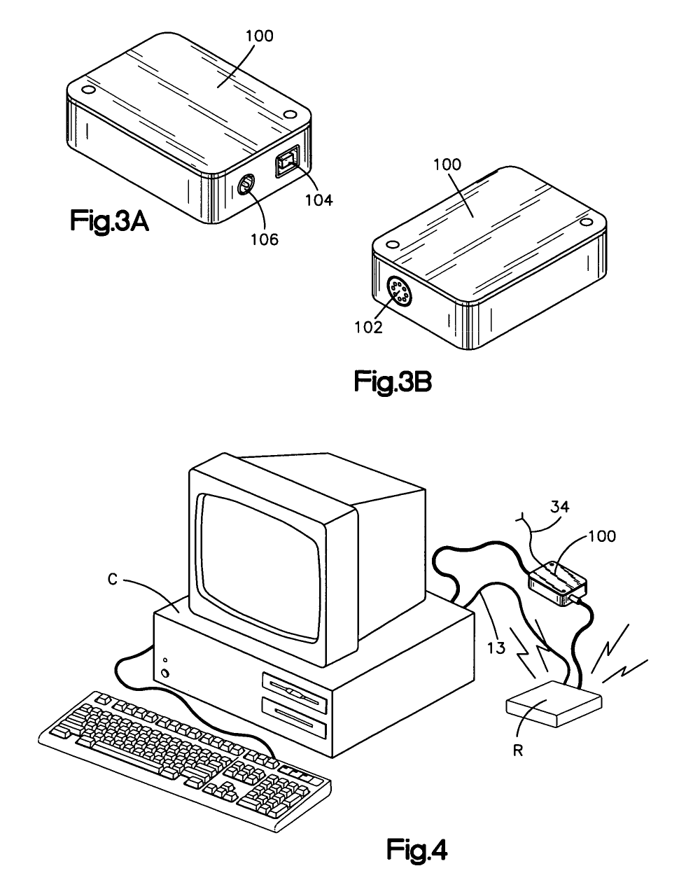

The FIG. 1 embodiment includes cables 12, 14 for routing signals into and out of the module 11. In an alternate embodiment shown in FIGS. 3A and 3B the module 11 is replaced by a housing 100 that rigidly supports connectors 102, 104 and includes a power input 106 for routing unregulated 12 volt signals into the housing. The housing 100 supports a custom circuit board to which the circuits 50, 60 and regulators 30, 31, 32, are attached. FIG. 4 is a depiction of this alternate embodiment coupled by cabling to a USB port on the back of a computer C. The output of the mini-din connector is coupled by means of cabling with a receiver R.

Although alternate embodiments of the invention have been described with a degree of particularity, it is the intent that the invention includes all modifications and alterations from the disclosed design falling within the spirit or scope of the appended claims.

What is claimed:

1. Apparatus comprising:
a power supply for providing a direct current signal for powering circuit components;
a communications circuit powered by the power supply including communications capability for transmitting serial data from a receiver to a computer;
a first connector for coupling an input to said communications circuit from said receiver; and
a second connector coupled to the communications circuit for providing signals at an output of said second connector to an interface of said computer.

2. The apparatus of claim 1 wherein the communications circuit comprises a conversion circuit powered by the power supply including communications capability for converting from one format signal to a second format signal.

3. The apparatus of claim 1 additionally comprising a regulator for providing an enable signal for enabling communications from a receiver to the communications circuit.

4. The apparatus of claim 3 wherein the enable signal is approximately five volts DC.

5. The apparatus of claim 1 wherein the second connector is a USB connector for coupling USB format signals from a computer.

6. Apparatus comprising:
a power supply for providing a direct current signal for powering circuit components;
a conversion circuit powered by the power supply including communications capability for converting from one format signal to a second format signal;
a first connector for coupling an input to said conversion circuit from a source of signals of said one format; and
a second connector coupled to the conversion circuit for providing signals of said second format signal to an output of said second connector;

7. The apparatus of claim 6 wherein the one formal signal adheres to the RS-232 format of communications signals and the second formal adheres to the USB format of serial communications signals.

8. The apparatus of claim 6 additionally comprising a regulator coupled to the power supply for providing regulated signal to a receiver coupled to the apparatus by the first connector.

9. The apparatus of claim 8 wherein the regulator provides an enable signal in addition to a power signal for coupling to said receiver.

10. Circuitry comprising:
a power supply for providing a direct current signal for powering circuit components;
a voltage regulator for receiving the direct current signal from the power supply and providing a stepped down voltage signal;
a conversion circuit including communications capability for converting from one format signal to a second format signal;
an input connector for coupling an RS-232 input to said conversion circuit to a source of RS-232 audio signals; and
an output connector coupled to the conversion circuit for providing signals of the audio signals that have been reformatted to Universal Serial Bus format signals.

11. A method for coupling an audio signal to a computer comprising:
providing a direct current signal for powering circuit components;
receiving an RS-232 input from a source of RS-232 audio signals of said one format;
establishing a communications link between said source and a conversion circuit; said conversion circuit converting from a RS-232 format signal to a Universal Serial Bus format signal; and
providing an output from the conversion circuit for providing signals of the audio signals that have been reformatted to Universal Serial Bus format signals.

12. Apparatus comprising:
a first connector for coupling an input signal from a receiver to an electronics module, wherein the input signal can be either a RS-232 format signal or Universal Serial Bus format signal;
a second connector coupled to said electronics module for providing an output signal to a computer, wherein the output signal can be either a RS-232 format signal or Universal Serial Bus format signal; and
a power supply that provides power to the electronics module, wherein said electronics module comprises a voltage regulator for providing power to the receiver through said first connector.

13. The apparatus of claim 12, wherein the electronics module comprises a conversion circuit capable of converting a RS-232 format signal to a Universal Serial Bus format signal and wherein said second connector is a USB connector.
